(19) United States
(12) Patent Application Publication
(10) Pub. No.: US 2014/0284237 A1
(43) Pub. Date: Sep. 25, 2014

(54) METHOD FOR ARRANGING PACKS OF CONTAINERS OF CIRCULAR OR OVAL CROSS SECTION, AND SET OF SUCH PACKS

(71) Applicant: Francois Gosset, Beuvillers (FR)

(72) Inventor: Francois Gosset, Beuvillers (FR)

(21) Appl. No.: 14/348,430

(22) PCT Filed: Sep. 28, 2012
(86) PCT No.: PCT/EP2012/069267

§ 371 Date: Mar. 28, 2014

(30) Foreign Application Priority Data
Sep. 30, 2011 (FR) 158834

(51) Int. Cl. B65G 57/20; B65D 71/06

(52) U.S. Cl. CPC B65G 57/20; B65D 71/06
USPC 206/427; 414/802

(57) ABSTRACT

The invention relates to a method of arranging a pack (10) of containers of circular or oval cross section in a set of rows and columns, characterized in that said columns of said pack are arranged in an alternation of adjacent columns that are either staggered or not staggered with respect to their adjacent columns, at least one set of at least two non-staggered columns (16, 17) having its two adjacent columns (15, 18) staggered in relation to it.

The invention also relates to a pack (10) obtained using the method, and a set of such packs (10).

The invention relates to the packaging of containers of circular or oval cross section, such as glass or plastic bottles or metal cans or food cans.

Packaging plants often send their clients substantially cylindrical containers, or in any case those having a circular or more or less oval cross section, such as glass or plastic bottles or metal cans or food cans, in the form of packs containing multiple such containers, enveloped in a plastic film. These packs often contain 6, 8, 12, 24 or more containers. These packs are next grouped together on palettes comprising X layers of Y packs so that they are easier to handle and transport in supply chains. Several pallet sizes exist, but the sizes depend on the supply-chain used, and not the characteristics of the containers to be packaged.

Most normally, within the pack, the containers are positioned in contact with each other in rows and columns forming a matrix, i.e., with successive rows and columns strictly facing each other. In such an arrangement, the containers have no more than 4 points of contact with the immediately adjacent containers. However, it is easy to see that the larger the number of containers, the more difficult it is to preserve such a “matrix” arrangement, since the stability of the pack becomes insufficient.

The containers tend to put themselves in an arrangement that will be described hereinafter as “staggered rows”, i.e., each row or each column is offset by a half-diameter of the container in relation to the immediately adjacent row or column. This displacement of the containers deforms the pack, and the plastic film then only envelops it loosely. The containers can then escape from it.

One answer to this problem consists of positioning of the containers, before they are wrapped in the film, on a tray having rims, or on a plate, which more or less prevents the containers from moving. The film covers both the containers and the plate or tray. However, this solution is expensive and complicates the wrapping of the packs. The problem also arises of recycling the plate or tray after unwrapping of the pack, since it must follow a different path from that of the plastic film.

As a result of these drawbacks, packs containing a large number of containers positioned in a matrix are often avoided.

In certain cases, the choice is therefore made to position the containers in staggered columns, deliberately, before they are wrapped by the film. Packs are thus obtained which clearly do not have a very regular perimeter, but the plastic film remains in contact with all of the containers situated on the periphery of the pack. Experience has shown that the packs may nevertheless have a sufficient rigidity, once covered, to be able to be transported without any risk of a container escaping from the pack. To that end, it suffices for the film to grip the containers with which it is in contact with enough pressure. This pressure is transmitted by the containers experiencing it to the containers with which they are in contact through the six points of contact of each container with its neighbors, and overall the pack then has an adequate rigidity, without it being necessary to position the containers on a plate or tray.

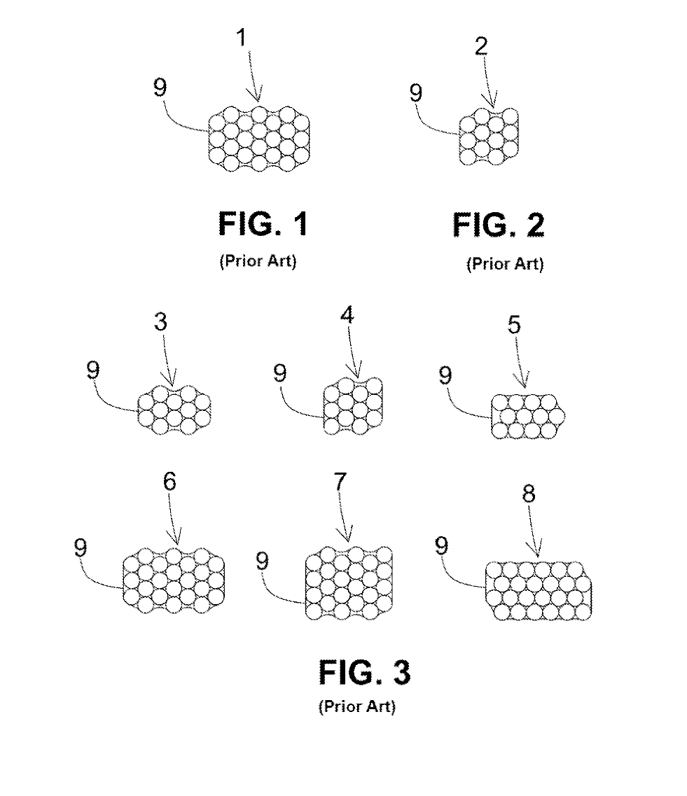

For example, for a pack of 24 containers, one of the known optimal arrangements in terms of rigidity and bulk of the pack consists of distributing the containers in 7 successive staggered columns of 3, 4, 3, 4, 3, 4, 3 containers, respectively. FIG. 1 shows one example of such an arrangement applied to a pack 1 of 24 containers.

For example, for a pack 2 of 12 containers, one of the known optimal arrangements in terms of rigidity and bulk of the pack consists of a distribution in 4 successive staggered columns of 3 containers, as shown in FIG. 2.

In light of these two arrangements of containers, it is easy to understand that different possible arrangements exist for a same number of containers making up the pack. FIG. 3 inventories the known staggered arrangements to produce packs 3-8 of 12 or 24 containers.

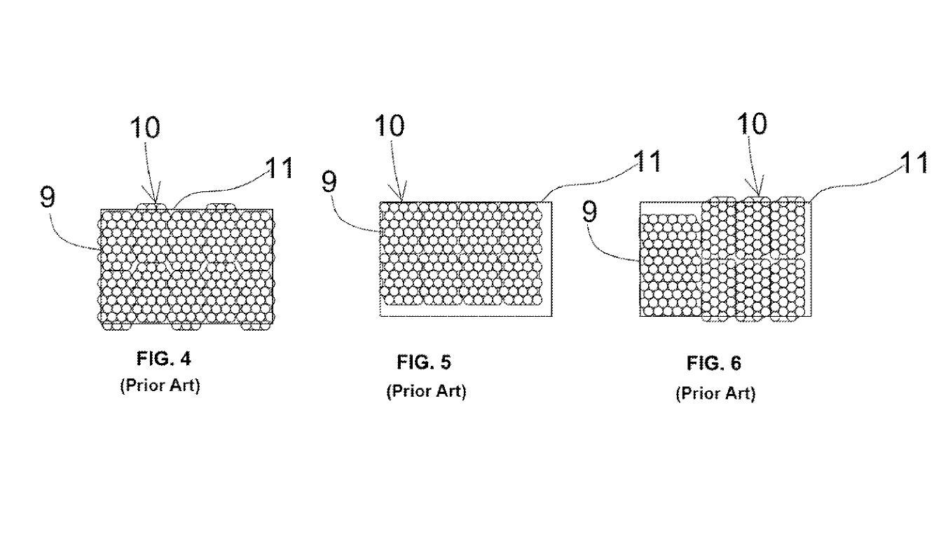

The rigidities of the packs 1-8 according to these different arrangements do not differ from each other significantly. For a given number of containers, the choice of the selected arrangement will therefore be made based on other criteria, which include, inter alia, the appearance of the pack, the quantity of film 9 necessary to wrap it, the difficulty and cost of obtaining such an arrangement by the packaging machine, but above all the possibility offered by the shape of the pack of arranging said packs 1-8 optimally to form an optimized layer of a set of such packs positioned on the pallet before they are shipped. This optimization of the bulk of the layer of packs aims to minimize transportation costs. FIG. 4 for example shows known possible arrangements of layers of packs 10 of 24 containers on a pallet 11, based on the shape of the pack. It is thus easy to see that the arrangement of FIG. 4 (10 packs) is particularly compact, and therefore more favorable than the arrangements of FIGS. 5 (8 packs) and 6 (9 packs). It is not, however, possible to have the bottoms of certain containers rest fully on the pallet 11 without having to significantly increase the area thereof relative to what would be an optimal area.

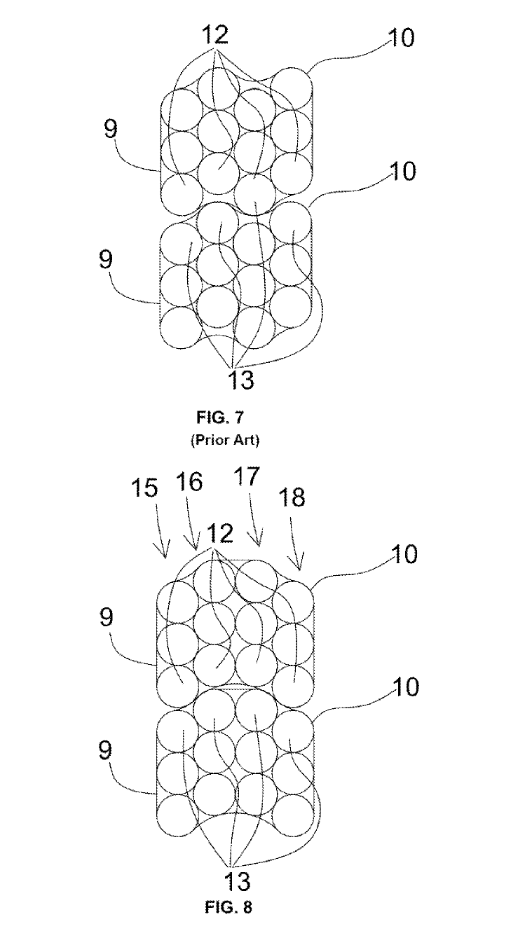

As shown in FIGS. 4 to 6, it is possible that the optimal arrangement of the packs 10 on the pallet 11 may require also staggering those packs 10 relative to each other. In other cases, it is possible that the optimal arrangement will be obtained by interlocking said packs 10 “behind one another” as shown in FIG. 7. In these two cases, however, the staggering or interlocking of the packs may not be done perfectly, due to the films 9, which, when correctly shrunk, do not have a concave enough shape to make it possible to put all of the containers 12, 13 of the two packs 10 facing each other in contact, which could reduce the overall bulk of the two packs 10.

In certain cases, it would be desirable to optimize the interlocking of the packs to increase the number of packs making up a pallet layer.

The aim of the invention is to give packagers of substantially cylindrical containers the possibility of producing a rigid enough arrangement of the containers making it possible to optimize the interlocking or staggering of several packs of containers on one pallet layer in order to optimize the number of packs contained on each layer of the pallet.

To that end, the invention relates to a method of arranging a pack of containers of circular or oval cross section in a set of rows and columns, characterized in that said columns of said pack are arranged in an alternation of adjacent columns that are either staggered or not staggered with respect to their adjacent columns, at least one set of at least two non-staggered columns having its two adjacent columns staggered in relation to it.

According to preferred embodiments, the method includes one or more of the following features, considered alone or according to any technically possible combination:
the arrangement is such that the containers situated at the periphery of the two successive packs are practically in contact with one another.
the arrangement is such that the containers situated at the periphery of two successive packs are in contact with one another.
the staggered columns have the same number of containers.
the non-staggered columns have the same number of containers.
each column has the same number of containers.
said pack includes twelve containers distributed in four columns of three containers, the two central columns of the pack being non-staggered and the two lateral columns being staggered relative to the central columns.

The invention also relates to a pack of containers of circular or oval cross section arranged in a set of rows and columns, characterized in that it has been arranged using the preceding method.

The invention also relates to a set of packs of containers of circular or oval cross section placed next to one another in an interlocking manner, characterized in that said packs are packs arranged as previously explained.

To that end, the invention relates to a method for arranging at least two packs of containers of circular or oval cross section in a set of rows and columns, characterized in that said columns of each pack are arranged in an alternation of adjacent columns that are either staggered or not staggered with respect to their adjacent columns, at least one set of at least two non-staggered columns having its two adjacent columns staggered in relation to it, the arrangement being such that the containers situated at the periphery of the two successive packs are practically in contact with one another.

According to other preferred embodiments, the method includes one or more of the following features, considered alone or according to any technically possible combination:
the arrangement is such that the containers situated at the periphery are in contact with one another.
the staggered columns have the same number of containers.
the non-staggered columns have the same number of containers.
each column has the same number of containers.
each pack includes twelve containers distributed in four columns of three containers, the two central columns of each pack not being staggered and the two lateral columns being staggered relative to the central columns.

The invention also relates to a set of packs of containers of circular or oval cross section placed next to one another in an interlocking manner. Said packs are packs of containers of circular or oval cross section arranged in a set of rows and columns using the method as previously described.

The invention is therefore based on the principle of reducing the space present between the containers immediately facing each other of two adjacent packs, that space being due to the insufficiently concave shape of the plastic film surrounding each pack.

To that end, the invention proposes a pack shape with an alternation of staggered and non-staggered columns, a staggered column being adjacent to at least one set of at least two non-staggered columns. In other words, for a set of at least two non-staggered columns, both of the adjacent columns, or the adjacent column if it is situated at the periphery of the pack, are staggered in relation to it.

This type of arrangement will be called semi-staggered in the rest of the text.

The invention will be better understood upon reading the following description, provided in reference to the following appended figures:

FIGS. 1 to 3, which show packs of containers arranged according to the prior art in a strictly staggered manner;

FIGS. 4 to 6, which show sets of strictly staggered packs, arranged according to the prior art;

FIG. 7, which shows a set of two packs arranged strictly staggered according to the prior art and positioned on a pallet in contact with each other;

FIG. 8, which shows a set of two packs arranged according to the invention and positioned on a pallet in contact with one another;

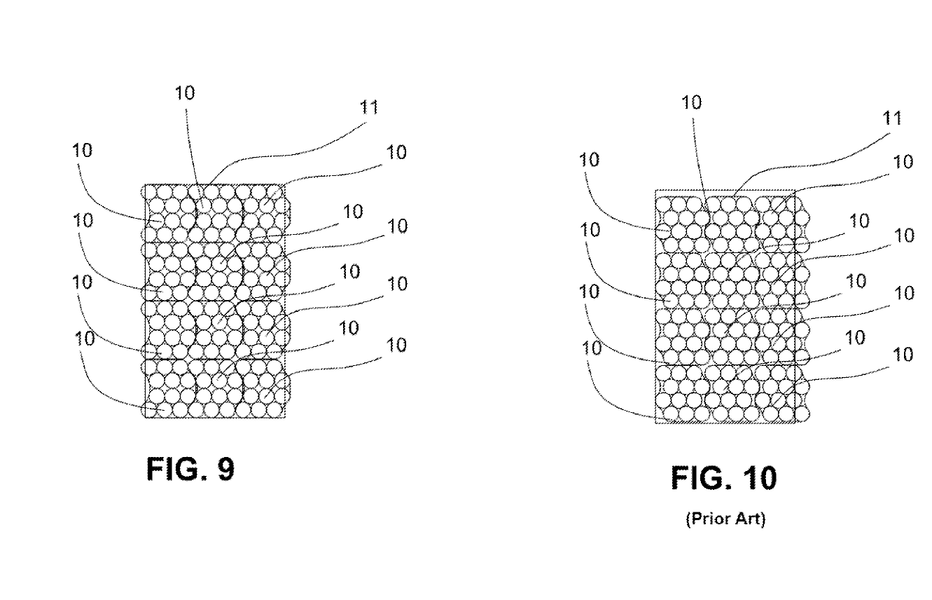

FIG. 9, which shows a set of twelve packs according to the invention positioned on a pallet; and

FIG. 10, which shows a set of twelve packs according to the prior art positioned on a pallet.

As an illustration, FIG. 8 shows two packs each positioned in an arrangement of 12 containers according to the principle of the invention and placed in contact with one another. Other numbers of containers may be considered.

Successively, the adjacent columns 15 and 16 are staggered, the adjacent columns 16 and 17 are not staggered, and the adjacent columns 17 and 18 are staggered. This arrangement allows the heat shrinking films 9 to shrink more significantly between the containers 12 and 13 situated at the periphery of two successive packs 10 while being close to each other, which allows said containers 12, 13 to be practically in contact with one another.

In this case, the interlocking of the packs 10 is substantially optimized relative to the traditional arrangement of FIG. 7, where the containers of each pack 10 are positioned in purely staggered columns.

Preferably, to further improve this effect, the containers 12, 13 are in contact with one another.

The rigidity of the semi-staggered pack according to the invention has rigidity characteristics equivalent to a traditional staggered pack.

FIG. 9, for example, shows an optimization of the number of packs 10 of twelve containers positioned on a pallet 11 owing to the semi-staggered arrangement of each of the packs 10. The interlocking of the completely staggered packs 10 shown in FIG. 10 does not make it possible to place twelve packs per layer on a pallet 11 identical to that of FIG. 9 due to the excessive overflow beyond the pallet 11 of several containers. The interlocking of the semi-staggered packs according to the invention makes it possible to place twelve packs per layer on a pallet 11 with dimensions that are as small as possible with a slight overhang that is acceptable for the supply chains.

The examples described and illustrated show examples of packs according to the invention that each include one or more sets of two non-staggered columns. However, it is possible to provide that at least one of the sets of non-staggered columns of a pack includes more than two such columns, for example three columns, the main point being that each group of non-staggered columns is separated from the closest non-staggered group(s) by a column that is staggered in relation to it.

The semi-staggered packs according to the invention may be produced easily through the methods currently used to stagger the packs in the packaging machines. There are documents that describe machines making it possible to sequence the containers of a pack based on a predetermined scheme, in particular using pushers that can offset the columns of containers in relation to one another. These machines may easily be adapted by one skilled in the art to the implementation of the present invention, in particular by acting on the shape of the pushers. Reference may for example be made to WO-A-98/45186, US-A-2010/0012462 or FR-A-1151821 to find a description of such machines.

It is easy to see that this principle may be extrapolated for any quantities of containers grouped together in packs under a heat shrinking plastic film.

1. A method of arranging at least two packs of containers of circular or oval cross section in a set of rows and columns, wherein said columns of said pack are arranged in an alternation of adjacent columns that are either staggered or not staggered with respect to their adjacent columns, at least one set of at least two non-staggered columns having its two adjacent columns staggered in relation to it, the arrangement being such that the containers situated at the periphery of the two successive packs are practically in contact with one another.

2. The method according to claim 1, wherein the arrangement is such that the containers situated at the periphery of two successive packs are in contact with one another.

3. The method according to claim 1, wherein the staggered columns have the same number of containers.

4. The method according to claim 1, wherein the non-staggered columns have the same number of containers.

5. The method according to claim 1, wherein each column has the same number of containers.

6. The method according to claim 1, wherein each pack comprises containers distributed in four columns of three containers, the two central columns of the pack being non-staggered and the two lateral columns being staggered relative to the central columns.

7. A set of packs of containers of circular or oval cross section placed next to one another in an interlocking manner, wherein said packs are packs of containers of circular or oval cross section arranged in a set of rows and column using the method according to claim 1.

8. The method according to claim 2, wherein the staggered columns have the same number of containers.

9. The method according to claim 2, wherein the non-staggered columns have the same number of containers.

10. The method according to claim 3, wherein the non-staggered columns have the same number of containers.

11. The method according to claim 8, wherein the non-staggered columns have the same number of containers.

12. The method according to claim 2, wherein each column has the same number of containers.

13. The method according to claim 3, wherein each column has the same number of containers.

14. The method according to claim 8, wherein each column has the same number of containers.

15. The method according to claim 4, wherein each column has the same number of containers.

16. The method according to claim 9, wherein each column has the same number of containers.

17. The method according to claim 10, wherein each column has the same number of containers.

18. The method according to claim 11, wherein each column has the same number of containers.

19. The method according to claim 2, wherein each pack includes containers distributed in four columns of three containers, the two central columns of the pack being non-staggered and the two lateral columns being staggered relative to the central columns.

20. The method according to claim 3, wherein each pack includes containers distributed in four columns of three containers, the two central columns of the pack being non-staggered and the two lateral columns being staggered relative to the central columns.
